(19) United States
(12) Patent Application Publication
(10) Pub. No.: US 2025/0377016 A1
(43) Pub. Date: Dec. 11, 2025

(54) MAGNETIC BEARING CONTROL DEVICE, MAGNETIC BEARING DEVICE, AND TURBO MACHINE

(71) Applicant: DAIKIN INDUSTRIES, LTD., Osaka-shi (JP)

(72) Inventors: Shumpei FUJIMOTO, Osaka-shi (JP); Atsushi SAKAWAKI, Osaka-shi (JP); Hiroshi HIBINO, Osaka-shi (JP)

(21) Appl. No.: 19/313,000

(22) Filed: Aug. 28, 2025

Related U.S. Application Data
(63) Continuation of application No. PCT/JP2024/007369, filed on Feb. 28, 2024.

(30) Foreign Application Priority Data
Mar. 31, 2023 (JP) 2023-058886

(51) Int. Cl. F16C 32/04

(52) U.S. Cl. CPC F16C 32/0444; F16C 32/0474

(57) ABSTRACT

A magnetic bearing device includes rotating body, a first magnetic bearing supporting the rotating body in a first direction, a first protective bearing supporting the rotating body in the first direction to reduce contact between the rotating body and the first magnetic bearing, and a second protective bearing supporting the rotating body in a second direction. A magnetic bearing control device includes a controller to control the magnetic bearing device. The first magnetic bearing receives a first current to make a first electromagnetic force act on the rotating body in the first direction. At a position adjustment time at which a first direction position of the rotating body with respect to the first protective bearing is adjusted, the magnetic bearing control device controls the first current to reduce a speed of the rotating body at a time of contact between the rotating body and the first protective bearing.

### CROSS-REFERENCE TO RELATED APPLICATIONS

This is a continuation of International Application No. PCT/JP2024/007369 filed on Feb. 28, 2024, which claims priority under 35 U.S.C. § 119 (a) to Patent Application No. 2023-058886, filed in Japan on Mar. 31, 2023, all of which are hereby expressly incorporated by reference into the present application.

### BACKGROUND

### Technical Field

The present disclosure relates to a magnetic bearing control device, a magnetic bearing device, and a turbo machine.

### Background Information

Japanese Unexamined Patent Publication No. 2019-173823 discloses a magnetic bearing device including a protective bearing (touchdown bearing).

### SUMMARY

A first aspect of the present disclosure is directed to a magnetic bearing control device. The magnetic bearing control device controls a magnetic bearing device. The magnetic bearing device includes: rotating body; a first magnetic bearing supporting the rotating body in a first direction, the first direction being one of an axial direction or a radial direction of the rotating body; a first protective bearing supporting the rotating body in the first direction to reduce contact between the rotating body and the first magnetic bearing; and a second protective bearing supporting the rotating body in a second direction, the second direction being the other one of the axial direction or the radial direction of the rotating body. The first magnetic bearing receives a first current to make a first electromagnetic force act on the rotating body in the first direction. At a position adjustment time at which a first-direction position of the rotating body in the first direction with respect to the first protective bearing is adjusted, the magnetic bearing control device controls the first current to reduce a speed of the rotating body at a time of contact between the rotating body and the first protective bearing.

### BRIEF DESCRIPTION OF THE DRAWINGS

FIG. 1 is a sectional view of a magnetic bearing device (10) according to a first embodiment.

FIG. 2 illustrates position adjustment of a rotating body (A) with respect to a front protective bearing (60) according to the first embodiment.

FIG. 3 is a flowchart illustrating a method for reducing damage of the front protective bearing (60) and a component fixed thereto according to the first embodiment.

FIG. 4 is a graph illustrating the method for reducing damage of the front protective bearing (60) and the component fixed thereto according to the first embodiment.

FIG. 5 is equivalent to FIG. 3 and illustrates a second embodiment.

FIG. 6 is equivalent to FIG. 4 and illustrates the second embodiment.

FIG. 7 is equivalent to FIG. 2 and illustrates a third embodiment.

FIG. 8 is equivalent to FIG. 2 and illustrates a fourth embodiment.

FIG. 9 is equivalent to FIG. 2 and illustrates a fifth embodiment.

FIG. 10 illustrates position adjustment of a rotating body (A) with respect to a rear protective bearing (70) according to a sixth embodiment.

### DETAILED DESCRIPTION OF EMBODIMENT(S)

### First Embodiment

### Magnetic Bearing Device

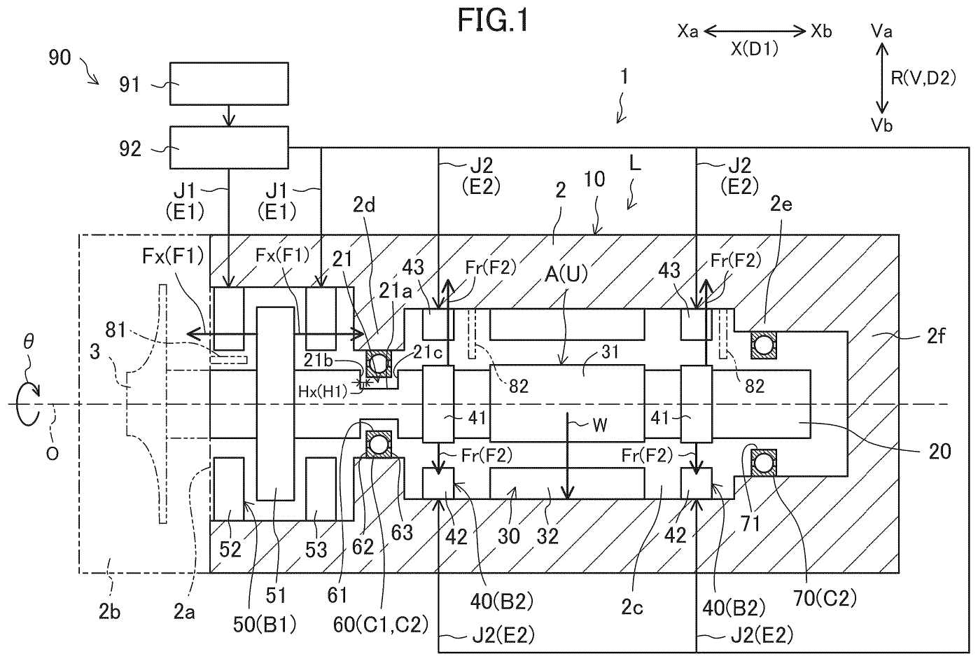

FIG. 1 is a sectional view of a magnetic bearing device (10) according to a first embodiment. The magnetic bearing device (10) is applied to a turbo compressor (1) as a turbo machine. The turbo compressor (1) is used for a refrigeration apparatus such as an air conditioner. The refrigeration apparatus includes a refrigerant circuit in which refrigerant circulates. The turbo compressor (1) compresses the refrigerant in the refrigerant circuit. The refrigerant circulates in the refrigerant circuit, thereby performing a vapor compression refrigeration cycle.

The turbo compressor (1) includes a housing (2), an impeller (3) as part of a rotating body (A), and the magnetic bearing device (10). The housing (2) and the impeller (3) will be described later.

The magnetic bearing device (10) includes a shaft (20) as part of the rotating body (A), a motor (30), a radial magnetic bearing (40) as a second magnetic bearing (B2), a thrust magnetic bearing (50) as a first magnetic bearing (B1), a front protective bearing (60) as a first protective bearing (C1) and a second protective bearing (C2), a rear protective bearing (70) as a second protective bearing (C2), an axial position sensor (81), a radial position sensor (82), and a magnetic bearing control device (90).

The axis (O) of the shaft (20) extends in the horizontal direction. The direction in which the axis (O) of the shaft (20) extends will be referred to as an axial direction (X) as a first direction (D1). The impeller (3) side in the axial direction (X) will be referred to as a front side in the axial direction (X). The side opposite to the impeller (3) in the axial direction (X) will be referred to as a rear side in the axial direction (X). The direction perpendicular to the axial direction (X) of the shaft (20) will be referred to as a radial direction (R) as a second direction (D2). A side away from the axis (O) of the shaft (20) in the radial direction (R) will be referred to as an outer (peripheral) side in the radial direction (R). A side closer to the axis (O) of the shaft (20) in the radial direction (R) will be referred to as an inner (peripheral) side in the radial direction (R). An upper side in the radial direction (R) in FIG. 1 corresponds to an upper side in the vertical direction (V), and will be simply referred to as an upper side. A lower side in the radial direction (R) in FIG. 1 corresponds to a lower side in the vertical direction (V), and will be simply referred to as a lower side. The direction of rotation of the shaft (20) about the axis (O) will be referred to as a circumferential direction (0).

The inside of the housing (2) is divided in the axial direction (O) by a wall portion (2a). Both end portions of the housing (2) in the axial direction (O) are closed. A front space (2b) on the front side of the wall portion (2a) in the housing (2) houses a front end portion of the shaft (20) and the impeller (3). A rear space (2c) on the rear side of the wall portion (2a) in the housing (2) houses most of the shaft (20), the motor (30), the radial magnetic bearing (40), the thrust magnetic bearing (50), the front protective bearing (60), the rear protective bearing (70), the axial position sensor (81), and the radial position sensor (82).

The impeller (3) is fixed to the front end portion of the shaft (20) so as to rotate integrally with the shaft (20). The impeller (3) is housed in the front space (2b) in the housing (2). A suction pipe and a discharge pipe are connected to the front space (2b). Gas introduced into the front space (2b) through the suction pipe is compressed in the front space (2b) to have a high pressure, and is discharged to the outside through the discharge pipe.

The motor (30) is housed in the rear space (2c) in the housing (2). The motor (30) has a motor rotor (31) as part of the rotating body (A) and a motor stator (32). The motor rotor (31) is fixed to an intermediate portion of the shaft (20) so as to rotate integrally with the shaft (20). The motor stator (32) is fixed to the inner peripheral surface of the housing (2). The outer peripheral surface of the motor rotor (31) and the inner peripheral surface of the motor stator (32) face each other with a predetermined space therebetween in the radial direction (R). The motor (30) rotates the shaft (20).

There are two radial magnetic bearings (40). The two radial magnetic bearings (40) are housed in the rear space (2c) in the housing (2). The two radial magnetic bearings (40) are arranged with the motor (30) interposed therebetween in the axial direction (X).

Each of the radial magnetic bearings (40) includes a radial magnetic bearing rotor (41) as part of the rotating body (A), an upper radial magnetic bearing stator (42), and a lower radial magnetic bearing stator (43). The radial magnetic bearing rotor (41) is fixed to the shaft (20) so as to rotate integrally with the shaft (20). The upper radial magnetic bearing stator (42) is fixed to an upper portion of the inner peripheral surface of the housing (2). The lower radial magnetic bearing stator (43) is fixed to a lower portion of the inner peripheral surface of the housing (2). The outer peripheral surface of the radial magnetic bearing rotor (41) and the inner peripheral surfaces of the upper radial magnetic bearing stator (42) and the lower radial magnetic bearing stator (43) face each other with a space therebetween in the radial direction (R).

The thrust magnetic bearing (50) is housed in the rear space (2c) in the housing (2). The thrust magnetic bearing (50) is arranged closer to the front side than the radial magnetic bearing (40) in the axial direction (X). The thrust magnetic bearing (50) includes a thrust magnetic bearing rotor (51) as part of the rotating body (A), a front thrust magnetic bearing stator (52), and a rear thrust magnetic bearing stator (53).

The thrust magnetic bearing rotor (51) is fixed to the shaft (20) so as to rotate integrally with the shaft (20). The front thrust magnetic bearing stator (52) and the rear thrust magnetic bearing stator (53) are fixed to the inner peripheral surface of the housing (2). The front thrust magnetic bearing stator (52) and the rear thrust magnetic bearing stator (53) are in a circular ring shape. The front thrust magnetic bearing stator (52) is arranged closer to the front side than the thrust magnetic bearing rotor (51) in the axial direction (X). The rear thrust magnetic bearing stator (53) is arranged closer to the rear side than the thrust magnetic bearing rotor (51) in the axial direction (X). The front surface of the thrust magnetic bearing rotor (51) and the rear surface of the front thrust magnetic bearing stator (52) face each other with a space therebetween in the axial direction (X). The rear surface of the thrust magnetic bearing rotor (51) and the front surface of the rear thrust magnetic bearing stator (53) face each other with a space therebetween in the axial direction (X).

The front protective bearing (60) is housed in the rear space (2c) in the housing (2). The front protective bearing (60) is arranged between the radial magnetic bearing (40) and the thrust magnetic bearing (50) in the axial direction (X). The front protective bearing (60) is in a circular ring shape. The front protective bearing (60) is also called a touchdown bearing. The front protective bearing (60) is fixed to a protrusion (2d) in the inner peripheral surface of the housing (2), protruding inward in the radial direction (R).

A portion of an outer peripheral portion of the shaft (20) facing the front protective bearing (60) is provided with a recess (21) recessed inward in the radial direction (R). The recess (21) includes an inner bottom surface (21a) located on the inner side in the radial direction (R), a front surface (21b) located on the front side in the axial direction (R), and a rear surface (21c) located on the rear side in the axial direction (R). The inner peripheral surface (61) of the front protective bearing (60) faces the inner bottom surface (21a) of the recess (21) of the shaft (20) in the radial direction (R). The front surface (62) of the front protective bearing (60) faces the front surface (21b) of the recess (21) of the shaft (20) in the axial direction (R). The rear surface (63) of the front protective bearing (60) faces the rear surface (21c) of the recess (21) of the shaft (20) in the axial direction (R).

A space between the front surface (62) and rear surface (63) of the front protective bearing (60) and the front surface (21b) and rear surface (21c) of the recess (21), respectively, is smaller than a space between the thrust magnetic bearing rotor (51) and each of the front thrust magnetic bearing stator (52) and the rear thrust magnetic bearing stator (53). Further, a space between the inner peripheral surface (61) of the front protective bearing (60) and the inner bottom surface (21a) of the recess (21) is smaller than a space between the radial magnetic bearing rotor (41) and each of the upper radial magnetic bearing stator (42) and the lower radial magnetic bearing stator (43).

The rear protective bearing (70) is housed in the rear space (2c) in the housing (2). The rear protective bearing (70) is arranged closer to the rear side than the radial magnetic bearing (40) in the axial direction (X). The rear protective bearing (70) is in a circular ring shape. The rear protective bearing (70) is also called a touchdown bearing. The rear protective bearing (70) is fixed to a protrusion (2e) in the inner peripheral surface of the housing (2), protruding inward in the radial direction (R).

The inner peripheral surface (71) of the rear protective bearing (70) faces the outer peripheral surface of the shaft (20) in the radial direction (R). A space between the inner peripheral surface (71) of the rear protective bearing (70) and the outer peripheral surface of the shaft (20) is smaller than a space between the radial magnetic bearing rotor (41) and each of the upper radial magnetic bearing stator (42) and the lower radial magnetic bearing stator (43).

The axial position sensor (81) is housed in the rear space (2c) in the housing (2). The axial position sensor (81) is fixed to the wall portion (2a) of the housing (2) in the vicinity of the thrust magnetic bearing (50). A detection unit of the axial position sensor (81) faces the thrust magnetic bearing rotor (51). The axial position sensor (81) detects a gap between the detection unit of the axial position sensor (81) and the thrust magnetic bearing rotor (51).

There are two radial position sensors (82). The radial position sensors (82) are housed in the rear space (2c) in the housing (2). Each of the radial position sensors (82) is fixed to the inner peripheral surface of the housing (2) in the vicinity of the corresponding radial magnetic bearing (40). The detection unit of the radial position sensor (82) faces the outer peripheral surface of the shaft (20). The radial position sensor (82) detects a gap between the detection unit of the radial position sensor (82) and the outer peripheral surface of the shaft (20).

The rotating body (A) includes the impeller (3), the shaft (20), the motor rotor (31), the radial magnetic bearing rotor (41), and the thrust magnetic bearing rotor (51).

The thrust magnetic bearing (50) supports the rotating body (A) in the axial direction (X). The thrust magnetic bearing (50) makes a thrust electromagnetic force (Fx) as a first electromagnetic force (F1) act on the rotating body (A) in the axial direction (X). The thrust electromagnetic force (Fx) acts forward (Xa) in the axial direction (X) between the front thrust magnetic bearing stator (52) and the thrust magnetic bearing rotor (51). The thrust electromagnetic force (Fx) acts rearward (Xb) in the axial direction (X) between the rear thrust magnetic bearing stator (53) and the thrust magnetic bearing rotor (51).

The radial magnetic bearing (40) supports the rotating body (A) in the radial direction (R). The radial magnetic bearing (40) makes a radial electromagnetic force (Fr) as a second electromagnetic force (F2) act on the rotating body (A) in the radial direction (R). The radial electromagnetic force (Fr) acts outward in the radial direction (R) and upward (Va) in the vertical direction (V) between the upper radial magnetic bearing stator (42) and the radial magnetic bearing rotor (41). The radial electromagnetic force (Fr) acts outward in the radial direction (R) and downward (Vb) in the vertical direction (V) between the lower radial magnetic bearing stator (43) and the radial magnetic bearing rotor (41).

The front protective bearing (60) supports the rotating body (A) in the axial direction (X) to reduce contact between the rotating body (A) and the thrust magnetic bearing (50). The front protective bearing (60) reduces contact between the thrust magnetic bearing rotor (51) and each of the front thrust magnetic bearing stator (52) and the rear thrust magnetic bearing stator (53). The front protective bearing (60) comes into contact with the rotating body (A) earlier than the thrust magnetic bearing (50), when the rotating body (A) moves in the axial direction (X).

Further, the front protective bearing (60) supports the rotating body (A) in the radial direction (X) to reduce contact between the rotating body (A) and the radial magnetic bearing (40). The front protective bearing (60) reduces contact between the radial magnetic bearing rotor (41) and each of the upper radial magnetic bearing stator (42) and the lower radial magnetic bearing stator (43). The front protective bearing (60) comes into contact with the rotating body (A) earlier than the radial magnetic bearing (40), when the rotating body (A) moves in the radial direction (R).

The rear protective bearing (70) supports the rotating body (A) in the radial direction (X) to reduce contact between the rotating body (A) and the radial magnetic bearing (40). The rear protective bearing (70) reduces contact between the radial magnetic bearing rotor (41) and each of the upper radial magnetic bearing stator (42) and the lower radial magnetic bearing stator (43). The rear protective bearing (70) comes into contact with the rotating body (A) earlier than the radial magnetic bearing (40), when the rotating body (A) moves in the radial direction (R).

### Magnetic Bearing Control Device

The magnetic bearing control device (90) is built in the magnetic bearing device (10). The magnetic bearing control device (90) includes a controller (91) as a control unit and a power source (92). A microcomputer and a program, for example, constitute the controller (91). The power source (92) supplies current to the radial magnetic bearing (40) and the thrust magnetic bearing (50) based on a command signal from the controller (91). The power source (92) is power controlled by, for example, pulse width modulation (PWM) method. The controller (91) receives a detection value of the axial position sensor (81) and a detection value of the radial position sensor (82).

The magnetic bearing control device (90) controls the magnetic bearing device (10). The magnetic bearing control device (90) supplies a first current (J1) to the thrust magnetic bearing (50). The magnetic bearing control device (90) applies a first voltage (E1) to the thrust magnetic bearing (50). The first current (J1) and the first voltage (E1) correspond to each other. The thrust magnetic bearing (50) receives the first current (J1) from the magnetic bearing control device (90), thereby making the thrust electromagnetic force (Fx) act on the rotating body (A) in the axial direction (X).

The magnetic bearing control device (90) supplies the first current (J1) to the front thrust magnetic bearing stator (52), thereby making the thrust electromagnetic force (Fx) act forward (Xa) in the axial direction (X) between the front thrust magnetic bearing stator (52) and the thrust magnetic bearing rotor (51) to cause the rotating body (A) to move forward (Xa) in the axial direction (X). The magnetic bearing control device (90) supplies the first current (J1) to the rear thrust magnetic bearing stator (53), thereby making the thrust electromagnetic force (Fx) act rearward (Xb) in the axial direction (X) between the rear thrust magnetic bearing stator (53) and the thrust magnetic bearing rotor (51) to cause the rotating body (A) to move rearward (Xb) in the axial direction (X).

The magnetic bearing control device (90) supplies a second current (J2) to the radial magnetic bearing (40). The magnetic bearing control device (90) applies a second voltage (E2) to the radial magnetic bearing (40). The second current (J2) and the second voltage (E2) correspond to each other. The radial magnetic bearing (40) receives the second current (J2) from the magnetic bearing control device (90), thereby making the radial electromagnetic force (Fr) act on the rotating body (A) in the radial direction (R).

The magnetic bearing control device (90) supplies the second current (J2) to the upper radial magnetic bearing stator (42), thereby making the radial electromagnetic force (Fr) act outward in the radial direction (X) and upward (Va) in the vertical direction (V) between the upper radial magnetic bearing stator (42) and the radial magnetic bearing rotor (41) to cause the rotating body (A) to move outward in the radial direction (X) and upward (Va) in the vertical direction (V). The magnetic bearing control device (90) supplies the second current (J2) to the lower radial magnetic bearing stator (43), thereby making the radial electromagnetic force (Fr) act outward in the radial direction (X) and downward (Vb) in the vertical direction (V) between the lower radial magnetic bearing stator (43) and the radial magnetic bearing rotor (41) to cause the rotating body (A) to move outward in the radial direction (X) and downward (Vb) in the vertical direction (V).

The magnetic bearing control device (90) supplies the first current (J1) to the thrust magnetic bearing (50) and supplies the second current (J2) to the radial magnetic bearing (40). The magnetic bearing control device (90) makes the thrust electromagnetic force (Fx) and the radial electromagnetic force (Fr) act on the rotating body (A) in the axial direction (X) and the radial direction (R). The magnetic bearing control device (90) performs magnetic levitation control on the rotating body (A) in the axial direction (X) and the radial direction (R). Hereinafter, the time of the magnetic levitation control on the rotating body (A) may sometimes be referred to as a magnetic levitation control time (L). At the magnetic levitation control time (L), the rotating body (A) does not come into contact with the front protective bearing (60) and the rear protective bearing (70).

Position Adjustment of Rotating Body with Respect to Front Protective Bearing

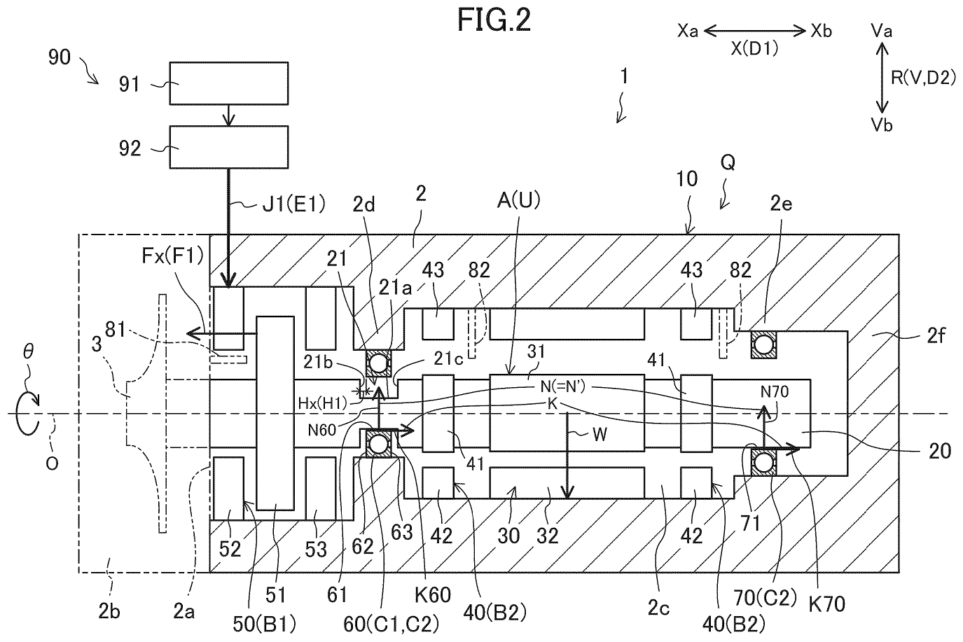

FIG. 2 illustrates position adjustment of the rotating body (A) with respect to the front protective bearing (60) according to this embodiment. In order that the front protective bearing (60) can function effectively, it is necessary to adjust (calibrate) an axial position (Hx) as a first-direction position (H1), which is the position of the rotating body (A) in the axial direction (X) with respect to the front protective bearing (60). In general, before magnetic levitation control is performed on the rotating body (A), the axial position (Hx) of the rotating body (A) in the axial direction (X) with respect to the front protective bearing (60) is adjusted while having the thrust electromagnetic force (Fx) of the thrust magnetic bearing (50) act on the rotating body (A).

Hereinafter, the time of adjustment of the axial position (Hx) of the rotating body (A) with respect to the front protective bearing (60) may be referred to as a position adjustment time (Q). In FIG. 2, the axial position (Hx) is represented by a distance between the front surface (21b) of the recess (21) of the shaft (20) and the front surface (62) of the front protective bearing (60).

At the position adjustment time (Q), the motor (30) is stopped. At the position adjustment time (Q), the axial position (Hx) of the rotating body (A) with respect to the front protective bearing (60) is adjusted. Specifically, at the position adjustment time (Q), the rotating body (A) is positioned at an intermediate position between the position of the rotating body (A) when the rear surface (21c) of the recess (21) of the shaft (20) comes into contact with the rear surface (63) of the front protective bearing (60) and the position of the rotating body (A) when the front surface (21b) of the recess (21) of the shaft (20) comes into contact with the front surface (62) of the front protective bearing (60). At the position adjustment time (Q), the magnetic bearing control device (90) receives the detection value of the axial position sensor (81).

At the position adjustment time (Q), the thrust electromagnetic force (Fx) of the thrust magnetic bearing (50) is made to act on the rotating body (A) in the axial direction (X), thereby causing the rotating body (A) to move. If a great thrust electromagnetic force (Fx) acts on the rotating body (A) at the position adjustment time (Q), the acceleration of the rotating body (A) increases significantly, and the speed (U) of the rotating body (A) increases. As a result, the rotating body (A) comes into contact with the front protective bearing (60) with great momentum, and the front protective bearing (60) and a component (e.g., retaining ring) fixed thereto may be damaged by the contact with the rotating body (A). Specifically, at the position adjustment time (Q), the rear surface (21c) of the recess (21) of the shaft (20) may come into contact with the rear surface (63) of the front protective bearing (60) strongly, or the front surface (21b) of the recess (21) of the shaft (20) may come into contact with the front surface (62) of the front protective bearing (60) strongly.

In this embodiment, a method described later is used to reduce damage of the front protective bearing (60) and components fixed thereto due to contact with the rotating body (A) at the position adjustment time (Q) for adjusting the axial position (Fx) of the rotating body (A) with respect to the front protective bearing (60) in the magnetic bearing device (10).

### Resultant Force Acting on Rotating Body

Hereinafter, the total of all the forces acting on the rotating body (A) in a state in which no current (J1, J2) is supplied to the radial magnetic bearing (40) and the thrust magnetic bearing (50) will be referred to as a resultant force (W). The resultant force (W) consists mainly of gravitation and magnetizing force. The gravitation acts on the rotating body (A) outward in the radial direction (R) and downward (Vb) in the vertical direction (V).

The magnetizing force acts mainly between the motor rotor (31) and the motor stator (32), between the radial magnetic bearing rotor (41) and the upper radial magnetic bearing stator (42), between the radial magnetic bearing rotor (41) and the lower radial magnetic bearing stator (43), between the thrust magnetic bearing rotor (51) and the front thrust magnetic bearing stator (52), and between the thrust magnetic bearing rotor (51) and the rear thrust magnetic bearing stator (53).

The magnetizing force is generated by a magnetic flux density remaining in the magnetic materials of the motor rotor (31), the motor stator (32), the magnetic bearing rotors (41, 51), and the magnetic bearing stators (42, 43, 52, 53) even when a magnetic field that was applied to the magnetic materials is reduced to zero. This magnetizing force acts even in a state in which no current (J1, J2) is supplied to the magnetic bearings (40, 50) and the motor (30). The magnetizing force acts on the rotating body (A) in various directions, i.e., the axial direction (X), the radial direction (R), and the circumferential direction (0).

Of the resultant force (W), the gravitation is dominant over the magnetizing force in many cases. In this example, for the sake of simplicity, the resultant force (W) is assumed to act outward in the radial direction (R) and downward (Vb) in the vertical direction (V).

### Movement of Rotating Body

In this embodiment, the magnetic bearing control device (90) supplies the first current (J1) to the thrust magnetic bearing (50), but does not supply the second current (J2) to the radial magnetic bearing (40), at the position adjustment time (Q) as illustrated in FIG. 2.

Since the second current (J2) is not supplied to the radial magnetic bearing (40) at the position adjustment time (Q), the radial electromagnetic force (Fr) does not act on the rotating body (A) in the radial direction (R). At the position adjustment time (Q), the rotating body (A) is caused to move outward in the radial direction (R) and downward (Vb) in the vertical direction (V) by the resultant force (W), and comes into contact with a lower portion of the inner peripheral surface (61) of the front protective bearing (60) and a lower portion of the inner peripheral surface (71) of the rear protective bearing (70).

The rotating body (A) is given a front normal force (N60) from the front protective bearing (60). The rotating body (A) is given a rear normal force (N70) from the rear protective bearing (70). The front normal force (N60) and the rear normal force (N70) act inward in the radial direction (R) and upward (Va) in the vertical direction (V). A total normal force (N), which is the total of the front normal force (N60) and the rear normal force (N70), is equal to the resultant force (W) (N=W).

Similarly, when the first current (J1) is not supplied to the thrust magnetic bearing (50), and the second current (J2) is not supplied to the radial magnetic bearing (40), as well, the rotating body (A) is moved outward in the radial direction (R) and downward (Vb) in the vertical direction (V) by the resultant force (W) and comes into contact with the inner peripheral surface (61) of the front protective bearing (60) and the inner peripheral surface (71) of the rear protective bearing (70). A total normal force (N′) at the time when the supply of the first current (J1) and the second current (J2) is stopped is equal to the magnitude of the vector of the resultant force (W) in the vertical direction (V)

In this embodiment, the total normal force (N) is equal to the total normal force (N′) of when the current supply is stopped (N=N′).

At the position adjustment time (Q), the magnetic bearing control device (90) supplies the first current (J1) to the front thrust magnetic bearing stator (52) of the thrust magnetic bearing (50) first, thereby making the thrust electromagnetic force (Fx) act forward (Xa) in the axial direction (X) on the rotating body (A) to cause the rotating body (A) to move forward (Xa) in the axial direction (X). At this time, the first current (J1) is not supplied to the rear thrust magnetic bearing stator (53) of the thrust magnetic bearing (50).

When the thrust electromagnetic force (Fx) acts forward (Xa) in the axial direction (X) on the rotating body (A), and the rotating body (A) is not yet moved, a front static frictional force (K60) of the front protective bearing (60) and a rear static frictional force (K70) of the rear protective bearing (70) act on the rotating body (A). The front static frictional force (K60) and the rear static frictional force (K70) act on the rotating body (A) in a direction opposite to a direction to which the rotating body (A) is to move. A total static frictional force (K), which is the total of the front static frictional force (K60) and the rear static frictional force (K70), is equal to the thrust electromagnetic force (Fx).

When the thrust electromagnetic force (Fx) acting forward (Xa) in the axial direction (X) on the rotating body (A) exceeds the maximum value (maximum static frictional force) of the total static frictional force (K), the rotating body (A) moves forward (Xa) in the axial direction (X), and the axial position (Hx) of the rotating body (A) with respect to the front protective bearing (60) changes.

Although not described in detail, the same also applies to a case in which the first current (J1) is supplied to the rear thrust magnetic bearing stator (53) of the thrust magnetic bearing (50) to cause the rotating body (A) to move rearward (Xb) in the axial direction (X). In the following description, supplying the first current (J1) to the front thrust magnetic bearing stator (52) of the thrust magnetic bearing (50) may be simply referred to as supplying the first current (J1) to the thrust magnetic bearing (50). Reduction in Damage of Front Protective Bearing

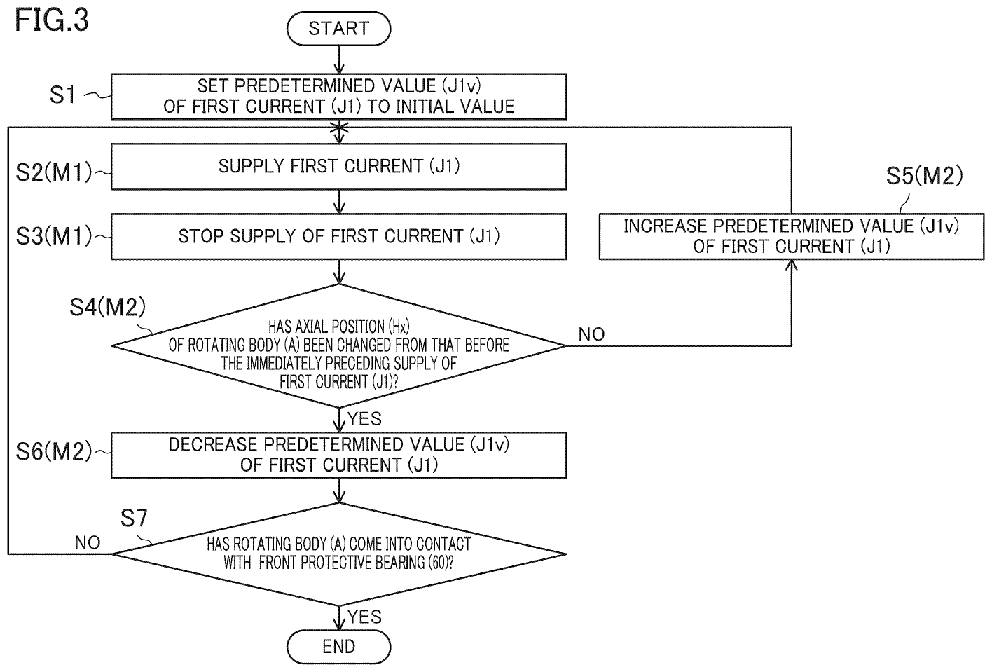

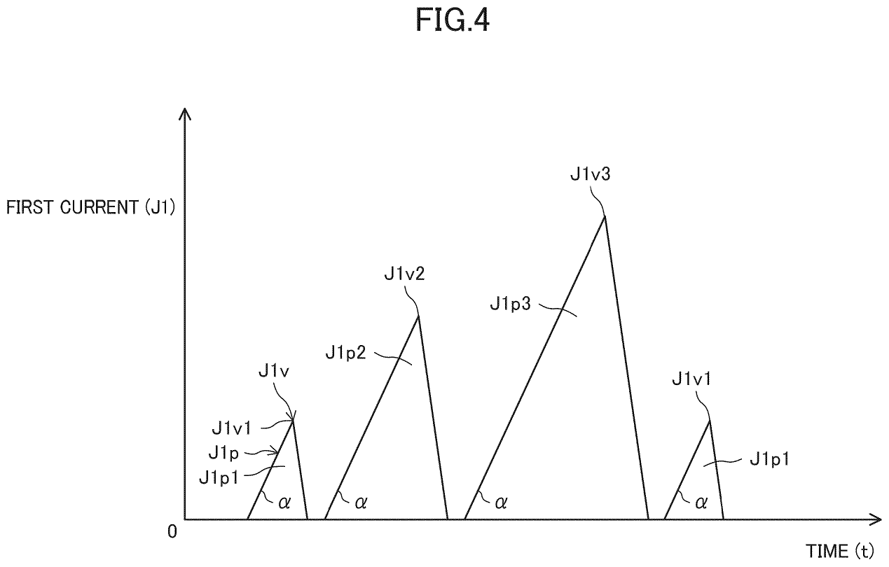

FIG. 3 is a flowchart illustrating a method for reducing damage of the front protective bearing (60) and the component fixed thereto according to this embodiment. FIG. 4 is a graph illustrating the method for reducing damage of the front protective bearing (60) and the component fixed thereto according to this embodiment. In FIG. 4, the horizontal axis represents a time (t) in units of, for example, [s], and the vertical axis represents the value of the first current (J1) in units of, for example, [A].

As illustrated in FIG. 4, in this embodiment, the first current (J1) supplied to the thrust magnetic bearing (50) is in a ramp form. In the first current (J1), a plurality of ramp waves (J1p) is continuously formed. The current increase rate (a) of each ramp wave (J1p) per time is constant. In this example, the ramp wave (J1p) is a triangular wave. Each ramp wave (J1p) rises and falls. The first current (J1) has a predetermined value (J1v) for each ramp wave (J1p).

As illustrated in FIG. 3, the magnetic bearing control device (90) repeatedly executes a first operation (M1) and a second operation (M2). In the first operation (M1), the first current (J1) of a predetermined value (J1v) is supplied to the thrust magnetic bearing (50), and then, the supply of the first current (J1) to the thrust magnetic bearing (50) is immediately stopped without referring to (checking) the axial position (Hx) of the rotating body (A).

In the second operation (M2), the predetermined value (J1v) is increased when the axial position (Hx) of the rotating body (A) does not change from that before the first current (J1) is supplied to the thrust magnetic bearing (50). In the second operation (M2), the predetermined value (Jv1) is decreased when the axial position (Hx) of the rotating body (A) changes from that before the first current (J1) is supplied to the thrust magnetic bearing (50).

As illustrated in FIG. 3, the process starts from “START,” and the predetermined value (J1v) of the first current (J1) is set to an initial value in the first step (S1). Specifically, in the first step (S1), the predetermined value (J1v) of the first current (J1) is set to a first predetermined value (J1v1). As illustrated in FIG. 4, the first predetermined value (J1v1) corresponds to the maximum value of a first ramp wave (J1p1). The first predetermined value (J1v1) is the smallest among predetermined values (J1v) greater than zero. Hereinafter, the predetermined value (J1v) corresponds to the maximum value of the ramp wave (J1p) of the same number. The predetermined value (J1v) is greater as the number increases.

The first operation (M1) is performed in the second step (S2) and the third step (S3). In the second step (S2), as part of the first operation (M1), the first current (J1) is supplied to the thrust magnetic bearing (50) with the ramp wave (J1p). Specifically, in the second step (S2), as part of the first operation (M1), the first current (J1) of the first predetermined value (J1v1) is supplied to the thrust magnetic bearing (50) with the first ramp wave (J1p1).

In the third step (S3), as part of the first operation (M1), the supply of the first current (J1) (first ramp wave (J1p1)) to the thrust magnetic bearing (50) is immediately stopped without referring to the axial position (Hx) of the rotating body (A).

In the fourth step (S4) to the sixth step (S6), the second operation (M2) is performed. In the fourth step (S4), as part of the second operation (M2), it is determined whether the axial position (Hx) of the rotating body (A) has changed from that before the immediately preceding supply of the first current (J1) (first ramp wave (J1p1)). The change in the axial position (Hx) of the rotating body (A) is detected based on the detection value of the axial position sensor (81).

If it is determined in the fourth step (S4) that the axial position (Hx) of the rotating body (A) has not been changed, the process proceeds to the fifth step (S5). In the fifth step (S5), as part of the second operation (M2), the predetermined value (J1v) of the first current (J1) is increased. Specifically, in the fifth step (S5), the predetermined value (J1v) of the first current (J1) is increased from the first predetermined value (J1v1) to a second predetermined value (J1v2). The second predetermined value (J1v2) corresponds to the maximum value of a second ramp wave (J1p2). After the predetermined value (J1v) of the first current (J1) is increased in the fifth step (S5), the process returns to the second step (S2).

The second step (S2) to the fifth step (S5) are repeated thereafter until the axial position (Hx) of the rotating body (A) changes from that before the immediately preceding supply of the first current (J1).

It is assumed that the predetermined value (J1v) of the first current (J1) is increased to a third predetermined value (J1v3) by repetition of the second step (S2) to the fifth step (S5) (see FIG. 4). The third predetermined value (J1v3) corresponds to the maximum value of a third ramp wave (J1p3).

In the second step (S2), as part of the first operation (M1), the first current (J1) of the third predetermined value (J1v3) is supplied to the thrust magnetic bearing (50) with the third ramp wave (J1p3). In the third step (S3), as part of the first operation (M1), the supply of the first current (J1) (third ramp wave (J1p3)) to the thrust magnetic bearing (50) is immediately stopped without referring to the axial position (Hx) of the rotating body (A).

In the fourth step (S4), as part of the second operation (M2), it is determined whether the axial position (Hx) of the rotating body (A) has changed from that before the immediately preceding supply of the first current (J1) (third ramp wave (J1p3)).

If it is determined in the fourth step (S4) that the axial position (Hx) of the rotating body (A) has been changed, the process proceeds to the sixth step (S6). In the sixth step (S6), as part of the second operation (M2), the predetermined value (J1v) of the first current (J1) is decreased. Specifically, in the sixth step (S6), the predetermined value (J1v) of the first current (J1) is decreased from the third predetermined value (J1v3) to the first predetermined value (J1v1) as the initial value. The first predetermined value (J1v1) corresponds to the maximum value of the first ramp wave (J1p1). When the predetermined value (J1v) of the first current (J1) is decreased in the sixth step (S6), the process proceeds to the seventh step (S7).

In the seventh step (S7), it is determined whether the rotating body (A) has come into contact with the front protective bearing (60). For example, it is determined in the seventh step (S7) whether the rear surface (21c) of the recess (21) of the shaft (20) has come into contact with the rear surface (63) of the front protective bearing (60). For example, the contact between the rotating body (A) and the front protective bearing (60) is detected based on the detection value of the axial position sensor (81).

If it is determined in the seventh step (S7) that the rotating body (A) has not come into contact with the front protective bearing (60), the process returns to the second step (S2). If it is determined in the seventh step (S7) that the rotating body (A) has come into contact with the front protective bearing (60), the process comes to END.

The magnetic bearing control device (90) repeatedly executes the first operation (M1) (second step (S2) and third step (S3)) and the second operation (M2) (fourth step (S4) to sixth step (S6)). At the position adjustment time (Q), the magnetic bearing control device (90) controls the supply of the first current (J1) to the thrust magnetic bearing (50) so as to reduce the speed (U) of the rotating body (A) at the time of contact between the rotating body (A) and the front protective bearing (60).

### Effects and Advantages

According to this embodiment, the magnetic bearing control device (90) reduces the speed (U) of the rotating body (A) at the time of contact between the rotating body (A) and the front protective bearing (60) at the position adjustment time (Q) at which the axial position (Hx) of the rotating body (A) with respect to the front protective bearing (60) is adjusted. In the magnetic bearing device (10), it is possible to reduce damage of the front protective bearing (60) and the component fixed thereto at the position adjustment time (Q) at which the axial position (Hx) of the rotating body (A) with respect to the front protective bearing (60) is adjusted.

The first operation (M1) and the second operation (M2) are repeatedly performed, so that the axial position (Hx) of the rotating body (A) with respect to the front protective bearing (60) changes in small steps. This is more advantageous in reducing the speed (U) of the rotating body (A) at the time of contact between the rotating body (A) and the front protective bearing (60).

In particular, according to this embodiment, reference is not made to the axial position (Hx) of the rotating body (A) in the first operation (M1); it is thus possible to change the axial position (Hx) of the rotating body (A) in smaller steps.

### Second Embodiment

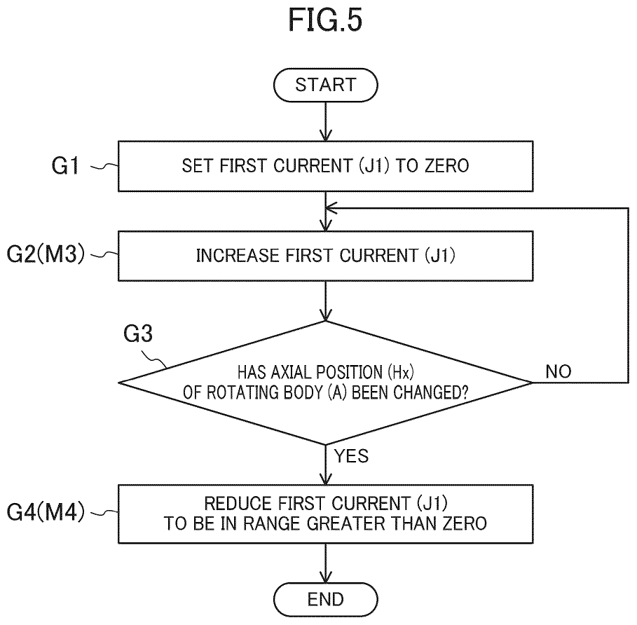

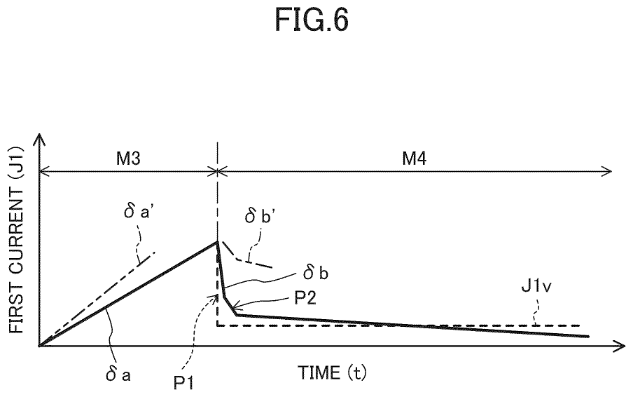

FIG. 5 is a flowchart illustrating a method for reducing damage of a front protective bearing (60) and a component fixed thereto according to a second embodiment, which is equivalent to FIG. 3. FIG. 6 is a graph illustrating the method for reducing damage of the front protective bearing (60) and the component fixed thereto according to the second embodiment, which is equivalent to FIG. 4. In FIG. 6, a broken line represents a first pattern (P1), and a solid line represents a second pattern (P2). In the following description of the second embodiment, components similar to those of the above-described embodiment are denoted by the same reference numerals, and detailed description thereof may be omitted.

As illustrated in FIGS. 5 and 6, the magnetic bearing control device (90) executes a third operation (M3) and a fourth operation (M4). In the third operation (M3), the first current (J1) for the thrust magnetic bearing (50) is increased until a change in the axial position (Hx) of the rotating body (A) with respect to the front protective bearing (60) is detected. In the fourth operation (M4), after the detection of the change in the axial position (Hx) of the rotating body (A) with respect to the front protective bearing (60), the first current (J1) for the thrust magnetic bearing (50) is reduced to be in a range greater than zero.

As illustrated in FIG. 6, the third operation (M3) and the fourth operation (M4) includes two types, i.e., the first pattern (P1) and the second pattern (P2).

Specifically, as illustrated in FIG. 5, the process starts from “START,” and the first current (J1) is set to zero in the first step (G1).

In a second step (G2), the third operation (M3) is performed. In the second step (G2), the first current (J1) is increased as the third operation (M3). The first current (J1) increases, for example, in a ramp shape.

In the third step (G3), a change in the axial position (Hx) of the rotating body (A) is detected. In the third step (G3), it is determined whether the axial position (Hx) of the rotating body (A) has changed.

If it is determined in the third step (G3) that the axial position (Hx) of the rotating body (A) has not been changed, the process returns to the second step (G2). If it is determined in the third step (G3) that the axial position (Hx) of the rotating body (A) has been changed, the process proceeds to the fourth step (G4).

In the fourth step (G4), the fourth operation (M4) is performed. In the fourth step (G4), as the fourth operation (M4), the first current (J1) is reduced to be in the range greater than zero. Then, the process comes to END.

As indicated by the broken line in FIG. 6, in the first pattern (P1), the fourth operation (M4) reduces the first current (J1) for the thrust magnetic bearing (50) to a predetermined value (J1v) greater than zero. The predetermined value (J1v) is a constant value greater than zero.

As indicated by the solid line in FIG. 6, in the second pattern (P2), the fourth operation (M4) reduces the first current (J1) for the thrust magnetic bearing (50) such that the speed (U) of movement of the rotating body (A) in the axial direction (X) be constant (such that the rate of change in the axial position (Hx) be constant).

As illustrated in FIG. 6, in the first pattern (P1) and the second pattern (P2), the magnetic bearing control device (90) supplies the first current (J1) to the thrust magnetic bearing (50) at a current change rate (Sa) smaller than the maximum current change rate (8′a) (see a dot-dot-dash line) of at the magnetic levitation control (L) on the rotating body (A) (magnetic levitation control time (L)), at the position adjustment time (Q) in the third operation (M3).

As illustrated in FIG. 6, in the first pattern (P1) and the second pattern (P2), the magnetic bearing control device (90) reverses the polarity of the first voltage (E1) to be applied to the thrust magnetic bearing (50) and thereafter stops the supply of the first current (J1) to the thrust magnetic bearing (50) in the fourth operation (M4). Reversing the polarity of the first voltage (E1) to be applied to the thrust magnetic bearing (50) reduces the first current (J1) for the thrust magnetic bearing (50) at a current change rate (8b) greater (in absolute value) than a current change rate (8′b) (see a dot-dot-dash line) of a case in which the polarity of the first voltage (E1) is not reversed.

The other configurations are similar to those of the first embodiment.

According to this embodiment, the first current (J1) for the thrust magnetic bearing (50) is reduced to be in the range greater than zero; therefore, the speed (U) of the rotating body (A) at the time of contact between the rotating body (A) and the front protective bearing (60) can be reduced without stopping the movement of the rotating body (A).

The speed (U) of the rotating body (A) at the time of contact can be easily reduced by setting the first current (J1) to the predetermined value (J1v).

The first current (J1) for the thrust magnetic bearing (50) is reduced such that the speed (U) of the movement of the rotating body (A) in the axial direction (X) is constant. It is thus possible to reduce the speed (U) of the rotating body (A) at the time of contact between the rotating body (A) and the front protective bearing (60) without stopping the movement of the rotating body (A) in the axial direction (X).

Reducing the current change rate (8a) at the time of current increase at the position adjustment time (Q) reduces a rapid increase in the first current (J1) for the thrust magnetic bearing (50). It is thus possible to reduce a rapid movement of the rotating body (A) in the axial direction (X).

Reversing the polarity of the first voltage (E1) to be applied to the thrust magnetic bearing (50) reduces the first current (J1) for the thrust magnetic bearing (50) at a current change rate (8b) greater (in absolute value) than a current change rate (8′b) of a case in which the polarity of the first voltage (E1) is not reversed. This is advantageous in reducing the speed (U) of the movement of the rotating body (A) in the axial direction (X).

### Third Embodiment

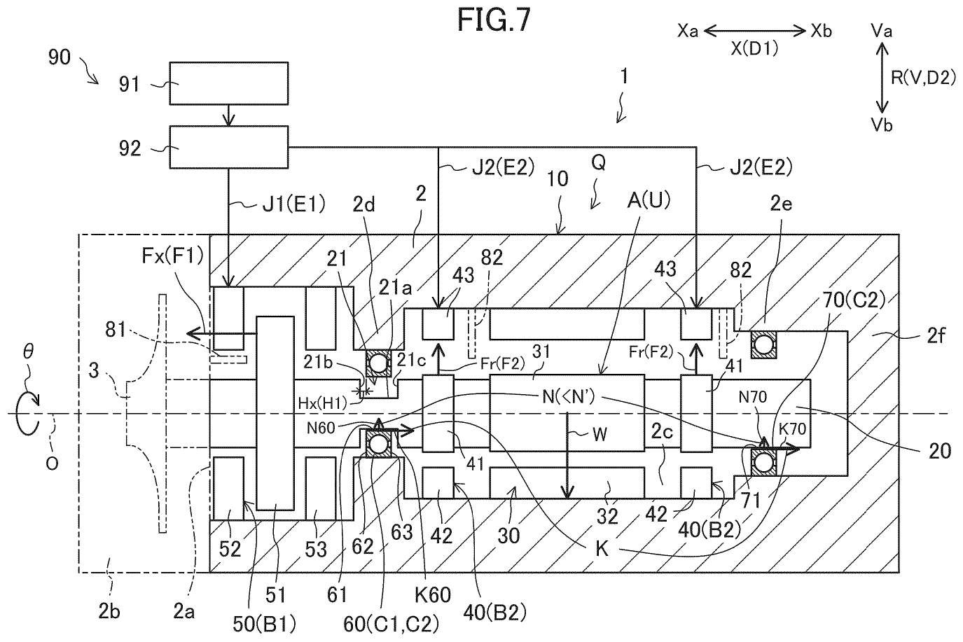

FIG. 7 illustrates position adjustment of a rotating body (A) with respect to a front protective bearing (60) according to a third embodiment, which is equivalent to FIG. 2. In the following description of the third embodiment, components similar to those of the above-described embodiments are denoted by the same reference numerals, and detailed description thereof may be omitted.

In this embodiment, as illustrated in FIG. 7, at the position adjustment time (Q), the magnetic bearing control device (90) supplies the first current (J1) to the thrust magnetic bearing (50), and also supplies the second current (J2) to the radial magnetic bearing (40). In particular, the magnetic bearing control device (90) supplies the second current (J2) to the upper radial magnetic bearing stator (42) of the radial magnetic bearing (40), but does not supply the second current (J2) to the lower radial magnetic bearing stator (43) of the radial magnetic bearing (40).

The magnetic bearing control device (90) receives the detection value of the axial position sensor (81) and the detection value of the radial position sensor (82).

Since the second current (J2) is supplied to the upper radial magnetic bearing stator (42) of the radial magnetic bearing (40), the radial electromagnetic force (Fr) acts on the rotating body (A) outward in the radial direction (R) and upward (Va) in the vertical direction (V). Meanwhile, the resultant force (W) acts outward in the radial direction (R) and downward (Vb) in the vertical direction (V) on the rotating body (A).

The magnetic bearing control device (90) supplies the second current (J2) to the radial magnetic bearing (40) such that the radial electromagnetic force (Fr) of the radial magnetic bearing (40) acting outward in the radial direction (R) and upward (Va) in the vertical direction (V) on the rotating body (A) is smaller than the resultant force (W) acting outward in the radial direction (R) and downward (Vb) in the vertical direction (V) on the rotating body (A).

Since the resultant force (W) acting downward (Vb) is greater than the radial electromagnetic force (Fr) acting upward (Va), the rotating body (A) comes into contact with the lower portion of the inner peripheral surface (61) of the front protective bearing (60) and the lower portion of the inner peripheral surface (71) of the rear protective bearing (70).

The rotating body (A) is given a front normal force (N60) from the front protective bearing (60). The rotating body (A) is given a rear normal force (N70) from the rear protective bearing (70). The front normal force (N60) and the rear normal force (N70) act inward in the radial direction (R) and upward (Va) in the vertical direction (V).

At the position adjustment time (Q), the total normal force (N) which is the total of the front normal force (N60) and the rear normal force (N70) is equal to a value obtained by subtracting the radial electromagnetic force (Fr) from the resultant force (W) (N=W−Fr).

In this embodiment, the total normal force (N) is smaller than the total normal force (N′) of when the supply of the first current (J1) and the second current (J2) is stopped (N<N′).

A front static frictional force (K60) of the front protective bearing (60) and a rear static frictional force (K70) of the rear protective bearing (70) act on the rotating body (A). The front static frictional force (K60) and the rear static frictional force (K70) act on the rotating body (A) in a direction opposite to a direction to which the rotating body (A) is to move. A total static frictional force (K), which is the total of the front static frictional force (K60) and the rear static frictional force (K70), is equal to the thrust electromagnetic force (Fx).

The magnetic bearing control device (90) supplies the second current (J2) to the radial magnetic bearing (40) such that the total normal force (N) of the front protective bearing (60) and the rear protective bearing (70) acting on the rotating body (A) is in a range smaller than the total normal force (N′) of when the supply of the first current (J1) and the second current (J2) is stopped, and greater than zero. The rotating body (A) does not levitate magnetically.

The other configurations are similar to those of the first embodiment and the second embodiment.

According to this embodiment, the rotating body (A) comes into contact with the inner peripheral surface (61) of the front protective bearing (60) and the inner peripheral surface (71) of the rear protective bearing (70). Since the total normal force (N) of the front protective bearing (60) and the rear protective bearing (70) acting on the rotating body (A) is smaller than that of when the supply of the first current (J1) and the second current (J2) is stopped, it is possible to reduce the maximum static frictional force acting on the rotating body (A) when the first current (J1) is supplied to start movement of the rotating body (A).

As a result, it is possible to reduce the thrust electromagnetic force (Fx) acting on the rotating body (A) and reduce a rapid movement of the rotating body (A) in the axial direction (X), which is advantageous in reducing the speed (U) of the rotating body (A) at the time of contact between the rotating body (A) and the front protective bearing (60).

### Fourth Embodiment

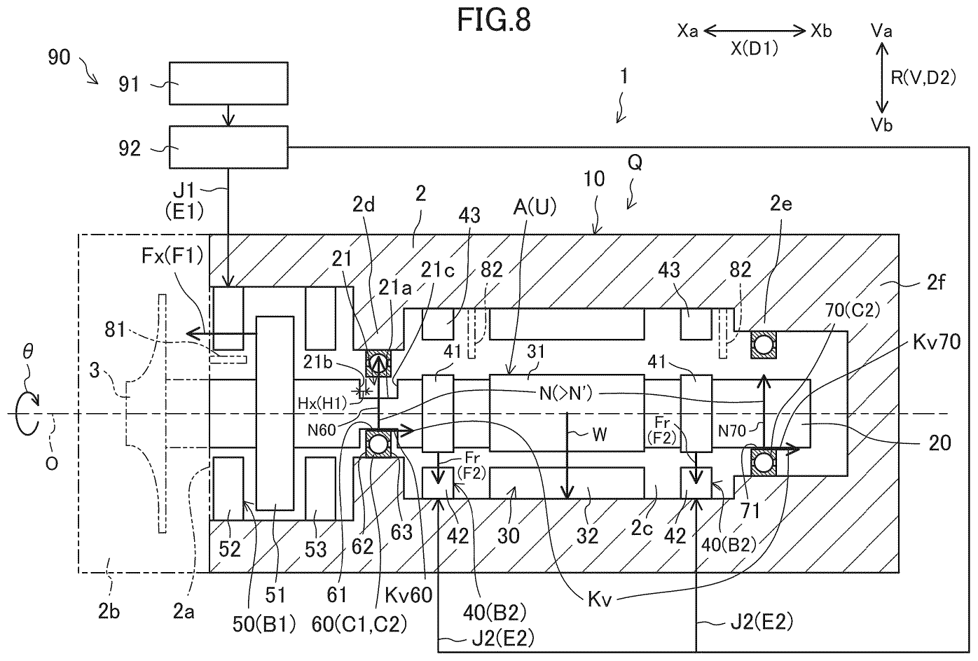

FIG. 8 illustrates position adjustment of a rotating body (A) with respect to a front protective bearing (60) according to a fourth embodiment, which is equivalent to FIG. 2. In the following description of the fourth embodiment, components similar to those of the above-described embodiments are denoted by the same reference numerals, and detailed description thereof may be omitted.

In this embodiment, as illustrated in FIG. 8, at the position adjustment time (Q), after the axial position (Hx) of the rotating body (A) has been changed, the magnetic bearing control device (90) stops the supply of the second current (J2) to the upper radial magnetic bearing stator (42) of the radial magnetic bearing (40), and supplies the second current (J2) to the lower radial magnetic bearing stator (43) of the radial magnetic bearing (40).

The radial electromagnetic force (Fr) and the resultant force (W) act outward in the radial direction (R) and downward (Vb) in the vertical direction (V) on the rotating body (A). The rotating body (A) comes into contact with a lower portion of the inner peripheral surface (61) of the front protective bearing (60) and a lower portion of the inner peripheral surface (71) of the rear protective bearing (70).

The rotating body (A) is given a front normal force (N60) from the front protective bearing (60). The rotating body (A) is given a rear normal force (N70) from the rear protective bearing (70). The front normal force (N60) and the rear normal force (N70) act inward in the radial direction (R) and upward (Va) in the vertical direction (V).

At the position adjustment time (Q), the total normal force (N) which is the total of the front normal force (N60) and the rear normal force (N70) is equal to the total of the resultant force (W) and the radial electromagnetic force (Fr) (N=W+Fr).

In this embodiment, the total normal force (N) is greater than the total normal force (N′) of when the supply of the first current (J1) and the second current (J2) is stopped (N>N′).

A front dynamic frictional force (Kv60) of the front protective bearing (60) and rear dynamic frictional force (Kv70) of the rear protective bearing (kv70) act on the rotating body (A). The front dynamic frictional force (Kv60) and the rear dynamic frictional force (Kv70) act on the rotating body (A) in a direction opposite to a direction to which the rotating body (A) is to move. A total dynamic frictional force (Kv) which is the total of the front dynamic frictional force (Kv60) and the rear dynamic frictional force (Kv70) is equal to the thrust electromagnetic force (Fx).

The magnetic bearing control device (90) supplies, after the axial position (Hx) of the rotating body (A) has been changed, the second current (J2) to the radial magnetic bearing (40) such that the total normal force (N) of the front protective bearing (60) and the rear protective bearing (70) acting on the rotating body (A) is greater than the total normal force (N′) of when the supply of the first current (J1) and the second current (J2) is stopped.

The other configurations are similar to those of the third embodiment.

According to this embodiment, the total normal force (N) of the front protective bearing (60) and the rear protective bearing (70) acting on the rotating body (A) is increased after the axial position (Hx) of the rotating body (A) has been changed, thereby making it possible to increase the total dynamic frictional force (Kv) acting on the rotating body (A). A rapid movement of the rotating body (A) in the axial direction (X) is reduced, which is advantageous in reducing the speed (U) of the rotating body (A) at the time of contact between the rotating body (A) and the front protective bearing (60).

### Fifth Embodiment

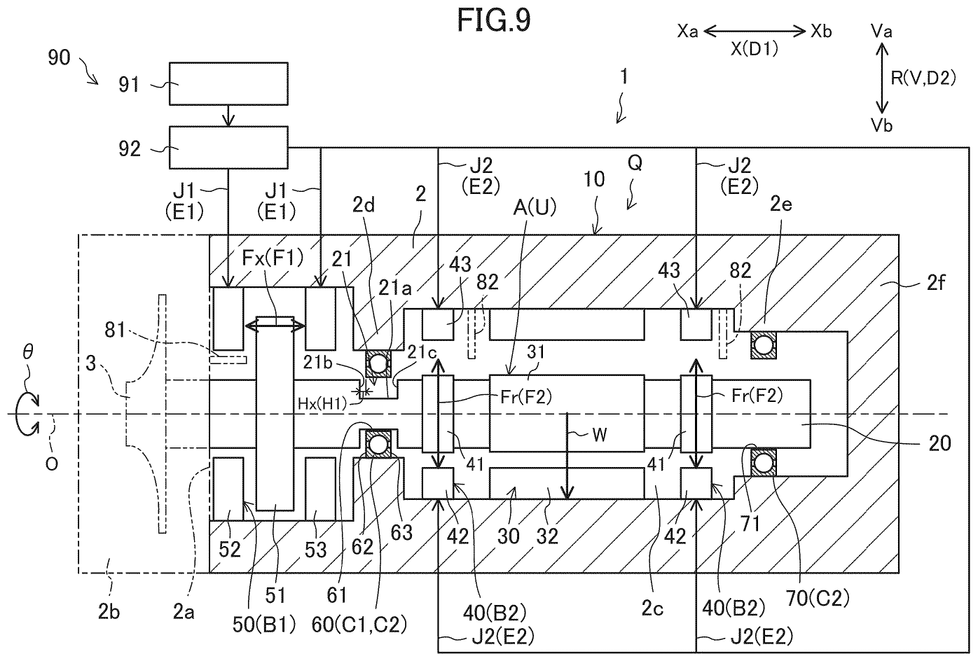

FIG. 9 illustrates position adjustment of a rotating body (A) with respect to a front protective bearing (60) according to a fifth embodiment, which is equivalent to FIG. 2. In the following description of the fifth embodiment, components similar to those of the above-described embodiments are denoted by the same reference numerals, and detailed description thereof may be omitted.

In this embodiment, as illustrated in FIG. 9, at the position adjustment time (Q), the magnetic bearing control device (90) supplies the first current (J1) to the thrust magnetic bearing (50), and also supplies the second current (J2) to the radial magnetic bearing (40).

In particular, the magnetic bearing control device (90) may supply the second current (J2) to the upper radial magnetic bearing stator (42) of the radial magnetic bearing (40), and may supply the second current (J2) to the lower radial magnetic bearing stator (43) of the radial magnetic bearing (40). Moreover, the magnetic bearing control device (90) may supply the first current (J1) not only to the front thrust magnetic bearing stator (52) of the thrust magnetic bearing (50), but also to the rear thrust magnetic bearing stator (53) of the thrust magnetic bearing (50).

The magnetic bearing control device (90) supplies the first current (J1) to the thrust magnetic bearing (50) or supplies the second current (J2) to the radial magnetic bearing (40) so as to vibrate the rotating body (A) in the circumferential direction (0).

The other configurations are similar to those of the third embodiment and the fourth embodiment.

According to this embodiment, the friction generated on the rotating body (A) changes from static friction to dynamic friction. It is therefore possible to reduce the frictional force acting on the rotating body (A) when the first current (J1) is supplied to the thrust magnetic bearing (50) to start movement of the rotating body (A). As a result, it is possible to reduce the thrust electromagnetic force (Fx) acting on the rotating body (A). A rapid movement of the rotating body (A) in the axial direction (X) is reduced, which is advantageous in reducing the speed (U) of the rotating body (A) at the time of contact between the rotating body (A) and the front protective bearing (60).

### Sixth Embodiment

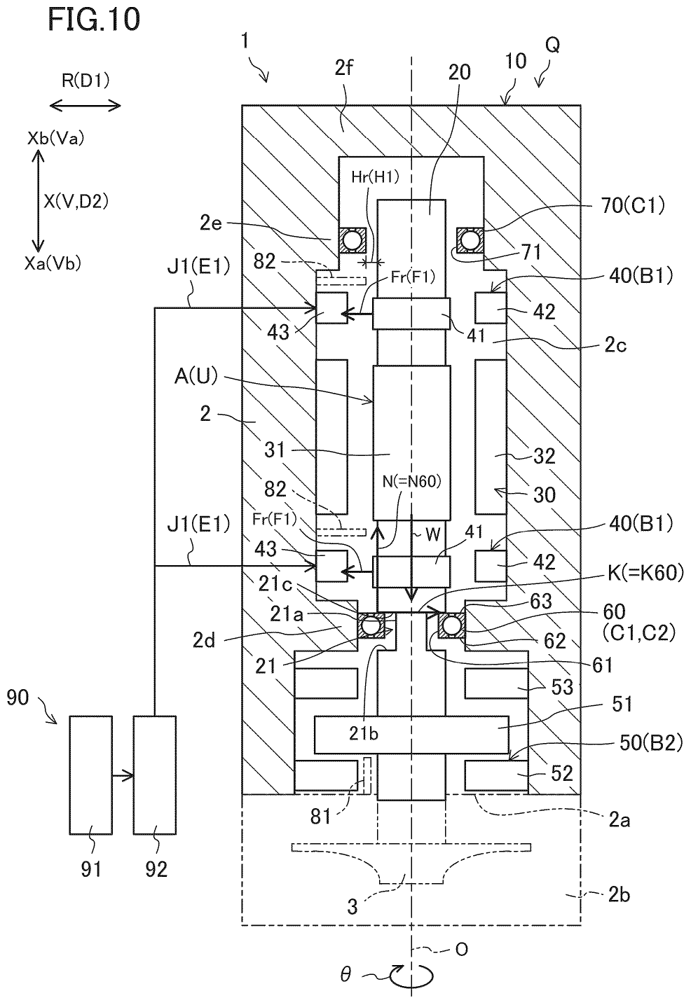

FIG. 10 illustrates position adjustment of a rotating body (A) with respect to a rear protective bearing (70) according to a sixth embodiment, which is equivalent to FIG. 2. In the following description of the sixth embodiment, components similar to those of the above-described embodiments are denoted by the same reference numerals, and detailed description thereof may be omitted.

The magnetic bearing device (10) includes a radial magnetic bearing (40) as a first magnetic bearing (B1), a thrust magnetic bearing (50) as a second magnetic bearing (B2), a front protective bearing (60) as a first protective bearing (C1) and a second protective bearing (C2), and a rear protective bearing (70) as the first protective bearing (C1).

The axis (O) of the shaft (20) extends in the vertical direction (V). The direction in which the axis (O) of the shaft (20) extends will be referred to as the axial direction (X) as the second direction (D2). The direction perpendicular to the axial direction (X) of the shaft (20) will be referred to as the radial direction (R) as the first direction (D1). Forward (Xa) in the axial direction (X) corresponds to downward (Vb) in the vertical direction (V). Rearward (Xb) in the axial direction (X) corresponds to upward (Va) in the vertical direction (V).

The magnetic bearing control device (90) supplies the second current (J2) to the thrust magnetic bearing (50). The magnetic bearing control device (90) applies the second voltage (E2) to the thrust magnetic bearing (50). The thrust magnetic bearing (50) receives the second current (J2) from the magnetic bearing control device (90), thereby making the thrust electromagnetic force (Fx) as the second electromagnetic force (F2) act on the rotating body (A) in the axial direction (X).

The magnetic bearing control device (90) supplies the first current (J1) to the radial magnetic bearing (40). The magnetic bearing control device (90) applies the first voltage (E1) to the radial magnetic bearing (40). The radial magnetic bearing (40) receives the first current (J1) from the magnetic bearing control device (90), thereby making the radial electromagnetic force (Fr) as the first electromagnetic force (F1) act on the rotating body (A) in the radial direction (R).

The position of the rotating body (A) in the radial direction (R) with respect to the rear protective bearing (70) will be referred to as a radial position (Hr) as the first-direction position (H1). The time of adjustment of the radial position (Hr) of the rotating body (A) with respect to the rear protective bearing (70) will be referred to as the position adjustment time (Q). In FIG. 10, the radial position (Hr) is represented by a distance between the outer peripheral surface (20a) of the shaft (20) and the inner peripheral surface (71) of the rear protective bearing (70).

The resultant force (W) consists mainly of the gravitation and the magnetizing force acts forward (Xa) in the axial direction (X) and downward (Vb) in the vertical direction (V). At the position adjustment time (Q), the rotating body (A) is caused to move forward (Xa) in the axial direction (X) and downward (Vb) in the vertical direction (V) by the resultant force (W). At the position adjustment time (Q), the rear surface (21c) of the recess (21) of the shaft (20) of the rotating body (A) comes into contact with the rear surface (63) of the front protective bearing (60).

The rotating body (A) is given a front normal force (N60) from the front protective bearing (60). The front normal force (N60) acts rearward (Xb) in the axial direction (X) and upward (Va) in the vertical direction (V). The front normal force (N60) is equal to the total normal force (N). The total normal force (N) is equal to the resultant force (W).

At the position adjustment time (Q), the magnetic bearing control device (90) supplies the first current (J1) to the radial magnetic bearing (40), thereby making the radial electromagnetic force (Fr) act on the rotating body (A) in the radial direction (R) to cause the rotating body (A) to move in the radial direction (R).

When the radial electromagnetic force (Fr) acts in the radial direction (R) on the rotating body (A), and the rotating body (A) is not yet moved, the front static frictional force (K60) of the front protective bearing (60) acts on the rotating body (A). The front static frictional force (K60) is equal to the total static frictional force (K). The total static frictional force (K) is equal to the radial electromagnetic force (Fr).

When the radial electromagnetic force (Fr) acting on the rotating body (A) in the radial direction (R) exceeds the maximum value (maximum static frictional force) of the total static frictional force (K), the rotating body (A) moves in the radial direction (R), and the radial position (Hr) of the rotating body (A) with respect to the rear protective bearing (70) changes.

At the position adjustment time (Q), the magnetic bearing control device (90) controls the supply of the first current (J1) to the radial magnetic bearing (40) so as to reduce the speed (U) of the rotating body (A) at the time of contact with the contact between the rotating body (A) and the rear protective bearing (70).

### OTHER EMBODIMENTS

In the first embodiment, the ramp wave (J1p) may be, for example, a sawtooth wave instead of the triangular wave. In the first embodiment, the first current (J1) may not be of the ramp wave (J1p) but be of a sine wave, for example.

In the first embodiment, in the second operation (M2), it is not necessary to decrease the predetermined value (J1v) of the first current (J1) to the initial value (first predetermined value (J1v1)) and a decrement by only one level from the immediately preceding predetermined value (J1v) may be enough.

A support mechanism of a bearing-less motor (motor having a function of supporting the shaft (20) in a noncontact manner) may be used as the radial magnetic bearing (40).

The thrust magnetic bearing rotor (51) may be divided into a front thrust magnetic bearing rotor and a rear thrust magnetic bearing rotor. In this case, the front thrust magnetic bearing stator (52) and the front thrust magnetic bearing rotor are disposed closer to the impeller (3) (front side (Xa)) in the axial direction (X) with respect to the motor (30), and the rear thrust magnetic bearing stator (53) and the rear thrust magnetic bearing rotor are disposed on the opposite side (rear side (Xb)) to the impeller (3) in the axial direction (X) with respect to the motor (30).

In the case of a sensor-less system (system configured to detect the position of the shaft (20) without using the position sensors (81, 82)), the position sensors (81, 82) may be omitted.

The axis (O) of the shaft (20) in the magnetic bearing device (10) (turbo compressor (1)) may extend in the horizontal direction as in the first to fifth embodiments, or may extend in the vertical direction (V) as in the sixth embodiment. The axis (O) of the shaft (20) may be inclined at an angle of less than 90 degrees with respect to the horizontal direction (or the vertical direction (V)).

In the above-described embodiments, the components of the magnetic bearing device (10) (turbo compressor (1)) are arranged such that the impeller (3) is disposed at the front side (Xa) end portion of the shaft (20) in the axial direction X, and that the thrust magnetic bearing (50), the front protective bearing (60), the radial magnetic bearing (40), the radial position sensor (82), the motor (30), the radial magnetic bearing (40), the radial position sensor (82), the rear protective bearing (70), and the axial position sensor (81) are disposed in this order from the impeller (3) toward the rear side (Xb) in the axial direction (X). However, the arrangement is not limited thereto. For example, the thrust magnetic bearing (50) may be disposed at the opposite (rear side (Xb)) end portion to the impeller (3) (front side (Xa)) in the axial direction (X). Similarly, the other components may be arranged at any positions as well.

The number of impellers (3) is not limited to one, and may be two or more. The attachment position of the impeller (3) is not limited to the front end portion of the shaft (20), and may be other portions, such as a rear end portion of the shaft (20) and a portion other than the end portions of the shaft (20). For example, two impellers (3) may be attached to the front end portion of the shaft (20) next to each other, or two impellers (3) may be attached to the front end portion and the rear end portion of the shaft (20) one by one.

The number of motors (30) may be two or more for the shaft (20).

It is not necessary that one protective bearing (C1, C2) has the functions of both the first protective bearing (C1) and the second protective bearing (C2). In this case, it is preferable to provide one protective bearing (C1, C2) for reducing contact with the thrust magnetic bearing (50) and two protective bearings (C1, C2) for reducing contact with the radial magnetic bearings (40).

The magnetic bearing control device (90) may be separated from the magnetic bearing device (10). The turbo machine (1) is not limited to the turbo compressor, and may be, for example, a pump. The magnetic bearing device (10) may be applied to a rotary machine (e.g., speed reducer) other than the turbo machine (1).

While the embodiments have been described above, it will be understood that various changes in form and details can be made without departing from the spirit and scope of the claims. The elements according to the embodiments, the variations thereof, and the other embodiments may be combined and replaced with each other.

1. A magnetic bearing control device for controlling a magnetic bearing device including: rotating body; a first magnetic bearing supporting the rotating body in a first direction, the first direction being one of an axial direction or a radial direction of the rotating body; a first protective bearing supporting the rotating body in the first direction to reduce contact between the rotating body and the first magnetic bearing; and a second protective bearing supporting the rotating body in a second direction, the second direction being the other one of the axial direction or the radial direction of the rotating body, the magnetic bearing control device comprising:
a controller configured to control the magnetic bearing device,
the first magnetic bearing receiving a first current to make a first electromagnetic force act on the rotating body in the first direction, and
at a position adjustment time at which a first-direction position of the rotating body in the first direction with respect to the first protective bearing is adjusted, the magnetic bearing control device controlling the first current to reduce a speed of the rotating body at a time of contact between the rotating body and the first protective bearing.

2. The magnetic bearing control device of claim 1, wherein
a first operation and a second operation are repeatedly executed,
the first operation is supplying the first current of a predetermined value and then stopping the supply of the first current, and
the second operation is
increasing the predetermined value when the first-direction position of the rotating body does not change from that before the supply of the first current and
decreasing the predetermined value when the first-direction position of the rotating body has changed from that before the supply of the first current.

3. The magnetic bearing control device of claim 1, wherein
a third operation and a fourth operation are executed,
the third operation is increasing the first current until a change in the first-direction position of the rotating body is detected, and
the fourth operation is reducing the first current to be in a range greater than zero after the change in the first-direction position of the rotating body has been detected.

4. The magnetic bearing control device of claim 3, wherein
the fourth operation reduces the first current to a predetermined value greater than zero.

5. The magnetic bearing control device of claim 3, wherein
the fourth operation reduces the first current such that the speed of movement of the rotating body in the first direction is constant.

6. The magnetic bearing control device of claim 1, wherein
at the position adjustment time, the first current is supplied at a current change rate smaller than a maximum current change rate of a case in which magnetic levitation control is performed on the rotating body.

7. The magnetic bearing control device of claim 1, wherein
the supply of the first current is stopped after a polarity of a first voltage to be applied to the first magnetic bearing is reversed.

8. The magnetic bearing control device of claim 1, wherein
the magnetic bearing device includes a second magnetic bearing supporting the rotating body in the second direction, and
the second magnetic bearing receives a second current to make a second electromagnetic force act on the rotating body in the second direction.

9. The magnetic bearing control device of claim 8, wherein
the second current is supplied to the second magnetic bearing such that a normal force of the second protective bearing acting on the rotating body is in a range
smaller than that of when the supply of the first current and the second current is stopped, and
greater than zero.

10. The magnetic bearing control device of claim 8, wherein
the first current or the second current is supplied so as to vibrate the rotating body in a circumferential direction.

11. The magnetic bearing control device of claim 8, wherein
the second current is supplied such that the normal force of the second protective bearing acting on the rotating body is greater than that of when the supply of the first current and the second current is stopped, after the first-direction position of the rotating body is changed.

12. The magnetic bearing control device of claim 8, wherein
the first direction is the axial direction, the second direction is the radial direction, the first magnetic bearing is a thrust magnetic bearing, and the second magnetic bearing is a radial magnetic bearing.

13. A magnetic bearing device including the magnetic bearing control device of claim 1.

14. A turbo machine including the magnetic bearing device of claim 13.
